(19) United States
(12) Patent Application Publication
(10) Pub. No.: US 2024/0063957 A1
(43) Pub. Date: Feb. 22, 2024

(54) TIME CONSTRAINTS FOR SCHEDULING SOUNDING REFERENCE SIGNALS (SRS) TRANSMISSION IN MULTIPLE COMPONENT CARRIERS (CCS)

(71) Applicant: Apple Inc., Cupertino, CA (US)

(72) Inventors: Yushu ZHANG, Beijing (CN); Haitong SUN, Cupertino, CA (US); Wenshu ZHANG, San Diego, CA (US); Seyed Ali Akbar FAKOORIAN, San Diego, CA (US); Amir Aminzadeh GOHARI, Sunnyvale, CA (US); Ruoheng LIU, San Diego, CA (US); Dawei ZHANG, Saratoga, CA (US); Wei ZENG, Saratoga, CA (US)

(73) Assignee: Apple Inc., Cupertino, CA (US)

(21) Appl. No.: 17/442,011

(22) PCT Filed: May 8, 2021
(86) PCT No.: PCT/CN2021/092341

§ 371 Date: Nov. 17, 2022

(51) Int. Cl. H04L 5/00; H04W 72/232; H04W 72/12

(52) U.S. Cl. CPC H04L 5/001; H04W 72/232; H04W 72/12; H04L 5/0048

(57) ABSTRACT

Some aspects of this disclosure relate to apparatuses and methods for implementing techniques for scheduling sounding reference signal transmission and switching in aggregated component carriers.

### BACKGROUND

### Field

The described aspects generally relate to scheduling sounding reference signal (SRS) transmissions in multiple component carriers (CCs).

### Related Art

The 3rd Generation Partnership Project (3GPP) has developed a new radio-access technology known as fifth generation (5G) New Radio (NR). Carrier aggregation can leverage multiple component carriers (CCs) to increase the effective bandwidth available to a user equipment (UE) in a wireless system such as a 5G NR system. Sounding Reference Signal (SRS) is an uplink (UL) reference signal transmitted by a UE to a base station. The transmission of SRS can be scheduled or triggered by a base station. The base station can use the SRS to estimate the channel condition. The base station may further use the channel estimate based on the SRS to select component carriers over which to perform downlink transmissions, as well as to select the parameters used to transmit the downlink transmissions. However, the transmission of SRS from the UE can be limited by conditions of CCs and the capability of the UE.

### SUMMARY

Some aspects of this disclosure relate to apparatuses and methods for implementing designs for time constraints related to sounding reference signal (SRS) carrier-based switching and simultaneous UL transmissions in aggregated component carriers (CCs) scheduled by a base station. A UE may be assigned a set of aggregated CCs, and the base station may transmit downlink signaling over one or more of those carriers. The UE may transmit sounding reference signal (SRS) symbols over the CCs so that the base station can generate a channel estimate for the CCs. In some examples, a UE may switch from the current CC to a target CC without a configured PUCCH/PUSCH, and then transmit SRS symbol over the target CC during a time period. A base station can schedule the transmission of SRS at the target CC as well as other uplink (UL) transmissions. Accordingly, carrier switching from current CC to a target CC for SRS transmission in the target CC may impact other simultaneous UL transmissions in multiple CCs besides the current CC and target CC. In some scenarios, a UE may not be able of simultaneously transmit uplink signaling over all CCs assigned to the UE, e.g., due to limits on UE capability.

In order to reduce the potential conflict and constraints on UL transmissions from the UE over other CCs, a base station can schedule the SRS transmission and switching according to some guidelines on time constraints to give the UE plenty of time to cancel any potential conflicting UL transmission on other CCs. For example, a base station can keep a time gap between the last symbol or end symbol of a Downlink Control Information (DCI) indicating Aperiodic SRS (Ap-SRS or A-SRS) on the target CC and the first symbol or start symbol of the earliest low priority UL transmission, among a group of overlapping UL transmissions with a priority lower than A-SRS, not to be less than, or equivalently greater than or equal to, T_{proc}^{max}, with T_{proc}^{max}=max {T_{proc}¹, . . . , T_{proc}ⁱ}, where T_{proc}ⁱ can be the processing time for the UE to cancel an UL transmission on i-th low priority carrier, or a constant shared by all CCs. The last symbol or end symbol are used interchangeably, and the first symbol and the start symbol are used interchangeably.

Alternatively, the base station can schedule a time gap between the first symbol of the overlapping low priority UL transmission in i-th carrier, and a last symbol of DCI indicating A-SRS on the target cell not to be less than, or equivalently greater than or equal to, T_{proc}ⁱ.

In another embodiments, a base station can keep the time gap between the first symbol of the earliest low priority SRS transmission on the target cell and a last symbol of the last DCI among all DCIs indicating high priority transmissions on another carriers, is not less than, or equivalently greater than or equal to, T_{proc}^{max}, with T_{proc}^{max}=max {T_{proc}¹, . . . , T_{proc}ⁱ, . . . }, where T_{proc}ⁱ is a processing time for the UE to switch and prepare for SRS transmission to the target cell. T_{proc}ⁱ=carrier-switching Time+N, where N is determined based on the UE UL processing capability of the target cell and SCS corresponding to the smallest SCS configurations between SCS for the PDCCH scheduling high priority UL, and SCS for the target cell. Alternatively, the base station can keep the gap between the first symbol of the earliest low priority SRS transmission on the target cell, and a last symbol of a DCI scheduling a high priority UL transmission on i-th carrier, is not less than, or equivalently greater than or equal to, T_{proc}ⁱ.

If the guidelines on the time constraints are not satisfied, the UE behavior can include one of the following (1) UE will not cancel low priority channel transmission (keep transmission of low priority channel), and UE will not transmit the high priority UL channel transmission; (2) UE will cancel low priority channel transmission, but UE will not transmit high priority channel transmission. The cancellation of low priority channel transmission will be partially or fully depend on UE capability; and (3) this will be an error case and UE behavior is undefined.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a wireless system for scheduling sounding reference signal (SRS) transmission and switching in aggregated component carriers (CCs), according to some aspects of the disclosure.

FIG. 2 illustrates a block diagram of a device to perform functions described herein, according to some aspects of the disclosure.

FIG. 3 illustrates an example method performed by a base station for scheduling a SRS transmission and switching in aggregated CCs, according to some aspects of the disclosure.

FIGS. 4A-4B illustrate example timing diagrams with time constraints for a base station to schedule a SRS transmission and switching in aggregated CCs, according to some aspects of the disclosure.

FIGS. 5A-5B illustrate example timing diagrams with time constraints for a base station to schedule a SRS transmission and switching in aggregated CCs, according to some aspects of the disclosure.

FIG. 6 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

For a wireless system such as a fifth generation (5G) New Radio (NR) system, multiple component carriers (CC), e.g., 5, or more, can be aggregated to form carrier aggregation (CA) to be jointly used for transmission to and from a user equipment (UE). Each aggregated carrier can be referred to as a component carrier (CC). In some systems, a component carrier can have a bandwidth of 1.4, 3, 5, 10, 15, or 20 MHz.

Sounding Reference Signal (SRS) is an uplink (UL) reference signal transmitted by a UE to a base station. SRS can provide information about the combined effect of multipath fading. The base station can use the SRS to estimate the channel condition. There are a few types of SRS, such as a periodic (P-SRS), a semi-persistent SRS (SP-SRS), or an aperiodic SRS (Ap-SRS or A-SRS). A P-SRS can be used for obtaining long-term channel information, which can be configured by higher layer signaling, such as radio resource control (RRC) signaling. The periodicity of P-SRS can vary such as between 2 ms to 320 ms. On the other hand, an Ap-SRS can be triggered either by downlink (DL) or uplink (UL) grant via physical downlink control channel (PDCCH) or Downlink Control Information (DCI). Once triggered, the UE can transmit a sounding sequence in a time scheduled by the DCI for one-time transmission.

In some examples, some CCs may be configured to support SRS transmissions without supporting uplink transmissions, such as physical uplink shared channel (PUSCH) or physical uplink control channel (PUCCH) transmissions, while other carriers can support both SRS transmissions and PUSCH/PUCCH transmissions. In some examples, the UE may perform SRS carrier switching in order to periodically, or aperiodically, transmit SRS symbols over the component carriers that do not support PUSCH/PUCCH transmissions. During SRS carrier switching, the UE may switch from the current CC to a target CC, and then transmit SRS over the target CC during a time period. The current CC can be referred to as a source CC as well.

SRS switching from a current CC to a target CC may impact simultaneous UL transmissions in multiple CCs besides the current CC and target CC. For a UE assigned with a set of CCs, the UE may be incapable of simultaneously transmitting uplink signals over all component carriers in the assigned CCs including the SRS transmission at the target CC. The impact of SRS carrier switching on the overlapping UL transmissions on other CCs may depend on various factors such as whether the simultaneous UL transmission is within UE capability or not, which itself depends on how UE capability reports are specified. Even if the simultaneous transmissions on the target and other carriers are supported by the UE capability, tuning to the target carrier for SRS transmission may result a “glitch” such as a temporary interruption on transmissions from other (victim) carriers.

However, some current wireless systems may have only considered the behavior of the base station and the UE for SRS switching on the current carrier and the target carrier, without specifying the UE or the base station behavior for other overlapping UL transmissions in other CCs. Embodiments herein present techniques and mechanisms to schedule SRS transmission and switching in aggregated CCs, considering the current carrier, the target carrier, and other CCs. Time constraints for scheduling SRS transmission and switching with multiple uplink transmissions in multiple CCs besides the source CC and the target CC are presented. The time constraints can limit the timing the DCIs used to trigger or schedule the SRS transmission on the target CC or other UL transmissions on other CCs. In addition, a UE can provide an enhancement in capability report to the base station so that the UE can indicate after the SRS switching, whether other UL transmissions are still within or beyond the UE capability. With the enhanced UE capability report, the base station can know the UE behavior accordingly after the SRS transmission.

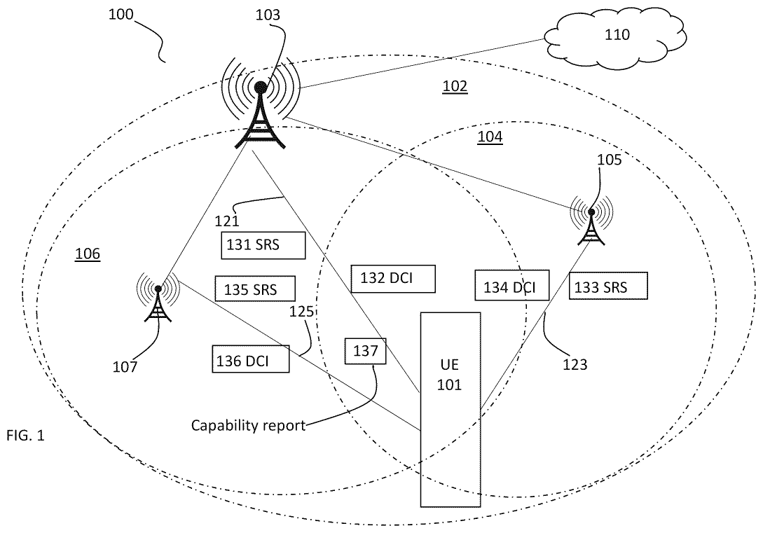

FIG. 1 illustrates a wireless system 100 for scheduling SRS transmission and switching in aggregated CCs, according to some aspects of the disclosure. Wireless system 100 is provided for the purpose of illustration only and does not limit the disclosed aspects. Wireless system 100 can include, but is not limited to, UE 101, a base station 103, a base station 105, and a base station 107, all communicatively coupled to a core network 110. UE 101 communicates with base station 103 over a carrier 121, communicates with base station 103 over a carrier 123 through base station 105, and communicates with base station 103 over a carrier 125 through base station 107. Carrier 121, carrier 123, and carrier 125 are component carriers between UE 101 and base station 103, and have slot formats comprised of DL and UL symbols.

In some examples, wireless system 100 can be a NR system, a LTE system, a 5G system, or some other wireless system. There can be other network entities, e.g., network controller, a relay station, not shown. Wireless system 100 can support a wide range of use cases such as enhanced mobile broad band (eMBB), massive machine type communications (mMTC), ultra-reliable and low-latency communications (URLLC), and enhanced vehicle to anything communications (eV2X).

According to some aspects, base station 103, base station 105, and base station 107 can be a fixed station or a mobile station. Base station 103, base station 105, and base station 107 can also be called other names, such as a base transceiver system (BTS), an access point (AP), a transmission/reception point (TRP), an evolved NodeB (eNB), a next generation node B (gNB), a 5G node B (NB), or some other equivalent terminology. In some examples, base station 103, base station 105, and base station 107 can be interconnected to one another and/or to other base station or network nodes in a network through various types of backhaul interfaces such as a direct physical connection, a virtual network, and/or the like, not shown.

According to some aspects, UE 101 can be stationary or mobile. UE 101 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, base station 103, base station 105, and base station 107 can be communicatively coupled to core network 110. Base station 103 can serve a cell 102, base station 105 can serve a cell 104 contained within cell 102, and base station 107 can serve a cell 106 contained within cell 102. In some other embodiments, cell 102 can overlap partially with cell 104 or cell 106. Cell 102, cell 104, and cell 106 can be a macro cell, a pico cell, a femto cell, and/or another type of cell. In comparison, a macro cell can cover a relatively large geographic area, e.g., several kilometers in radius, a femto cell can cover a relatively small geographic area, e.g., a home, while a pico cell covers an area smaller than the area covered by a macro cell but larger than the area covered by a femto cell. For example, cell 102 can be a macro cell, and cell 104 and cell 106 can be a pico cell or a femto cell. In some examples, the geographic area of a cell can move according to the location of a mobile base station.

According to some aspects, base station 103 can be the serving base station, and cell 102 can be the serving cell or primary cell. Cell 104 and cell 106 can be a secondary cell, or a primary secondary cell. There can be other secondary cells for UE 101, not shown. Data for UE 101 can be simultaneously transferred between UE 101 and core network 110 by a radio connection between UE 101 and base station 103 at carrier 121, a radio connection between UE 101 and base station 105 at carrier 123, and a radio connection between UE 101 and base station 107 at carrier 125.

According to some aspects, UE 101 can transmit SRS on the CCs to base station 103. For example, UE 101 can transmit SRS 131 over carrier 121, transmit SRS 133 over carrier 123, and transmit SRS 135 over carrier 125, to base station 103. SRS 131, SRS 133, and SRS 135 can be a P-SRS, a SP-SRS, or an Ap-SRS. Accordingly, transmissions of SRS 131, SRS 133, and SRS 135 can be scheduled by base station 103 by various means. For example, if SRS 131 is a P-SRS, SRS 131 can be scheduled by a RRC signaling from base station 103. If SRS 131 is an Ap-SRS, SRS 131 can be scheduled by DCI 132 from base station 103. Similarly, if SRS 133 is an Ap-SRS, SRS 133 can be scheduled by DCI 134 from base station 103; and if SRS 135 is an Ap-SRS, SRS 135 can be scheduled by DCI 136 from base station 103.

According to some aspects, UE 101 can transmit other UL transmissions such as PUSCH or PUCCH on any of the CCs, e.g., carrier 121, carrier 123, or carrier 125, not shown. In some examples, some CCs may be configured to support SRS symbol transmissions without supporting uplink transmission, such as PUSCH or PUCCH transmissions, while other carriers can support both SRS symbol transmissions and PUSCH/PUCCH transmissions. In some embodiments, the UE may perform SRS switching in order to periodically, or aperiodically, transmit SRS symbols over the component carriers that do not support PUSCH/PUCCH transmissions.

There can be some prioritization rules defined for simultaneous transmission of SRS on the target carrier and UL transmissions on other carriers. The prioritization rules can specify which UL transmissions are dropped once simultaneous UL transmissions are beyond UE's indicated UL-CA capability. For example, if the SRS 131 is an Ap-SRS, SRS 131 may have higher priority than other UL transmissions on other carriers. On the other hand, if the SRS 131 is a P-SRS, SRS 131 may have a lower priority than some UL transmissions on other carriers.

In addition, UE 101 can transmit a capability report 137 to report to base station 103 the UE capability to support simultaneous UL transmissions besides the SRS transmissions. If UE 101 reports the target cell for SRS carrier switching as part of UE's UL-CA capability reports, the simultaneous transmissions only on the reported bands, or Band Combination (BC), or Feature Set (FS), or Feature Set Per Component-carrier FSPC is assumed to be under UE's capability, otherwise the base station can consider all simultaneous transmissions on other UL carriers as being beyond UE's capability. In some examples, target cell for SRS carrier switching can be a DL carrier that is not configured with PUCCH/PUSCH (UE only switches to this carrier for SRS transmission). Other UL carriers can be regular UL carriers that can be inter-band or intra-band with the source carrier or the current carrier. For example, UE 101 can indicate parallelTxSRS-PUCCH-PUSCH for band combination C1 and C2 (both UL carriers), but not for C0 and C2 (C0 is DL carrier). If UE 101 is indicated to switch from C1 to C0, base station 103 cannot assume that UE is capable to simultaneously transmit SRS on C0 and PUCCH/PUSCH on C2. In some other examples, UE 101 indicates parallelTxSRS-PUCCH-PUSCH for band combination C1 and C2 (both UL carriers), and for C0 and C2 (C0 is DL carrier). If UE is indicated to switch from C1 to C0, base station 103 can assume UE is capable to simultaneously transmit SRS on C0 and PUCCH/PUSCH on C2.

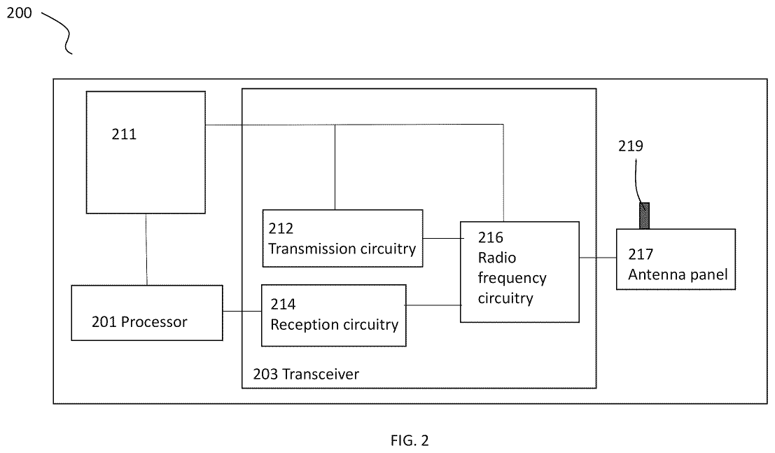

FIG. 2 illustrates a block diagram of a device 200, having antenna panel 217 including one or more antenna elements, e.g., an antenna element 219 coupled to transceiver 203 and controlled by processor 201. Device 200 can be used to implement UE 101 or base station 103. In detail, transceiver 203 can include radio frequency (RF) circuitry 216, baseband transmission circuitry 212, and baseband reception circuitry 214. RF circuitry 216 can include multiple parallel RF chains for one or more of transmit or receive functions, each connected to one or more antenna elements of the antenna panel. In addition, processor 201 can be communicatively coupled to a memory device 211, which are further coupled to the transceiver 203. Memory device 211 can include instructions, that when executed by the processor 201 perform the functions to implement time constraints related to scheduling SRS transmission and carrier-based switching in CC aggregation described herein. Alternatively, the processor 201 can be “hard-coded” to perform the functions described herein.

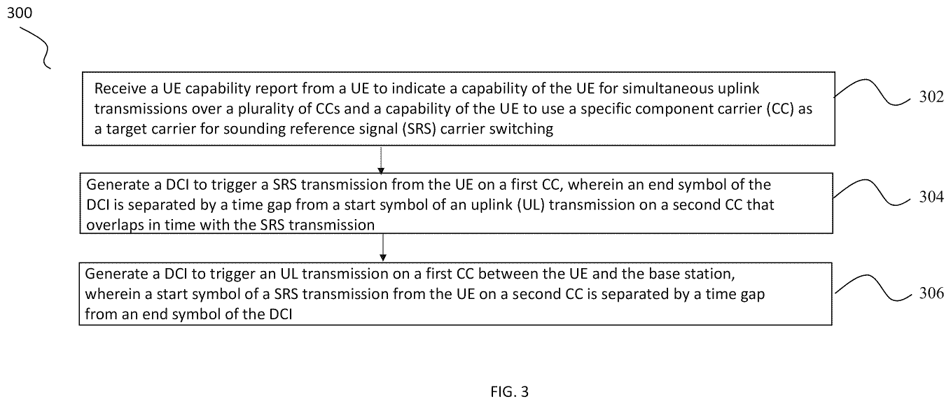

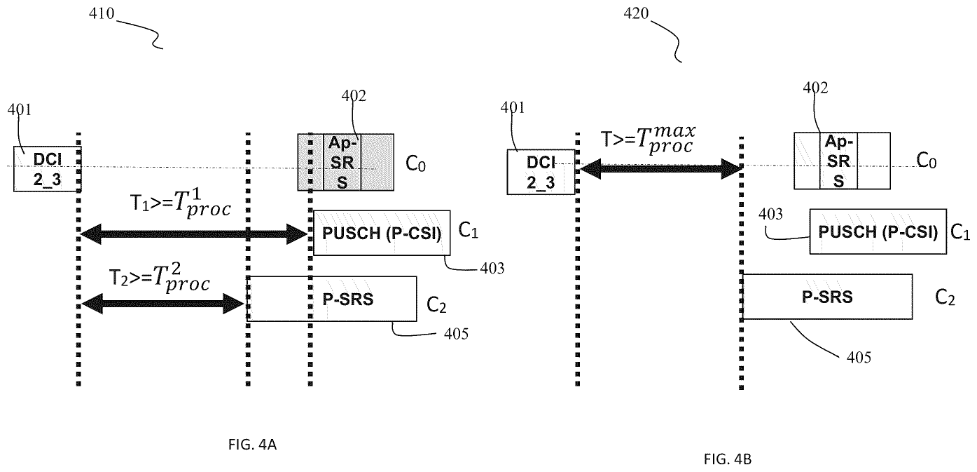

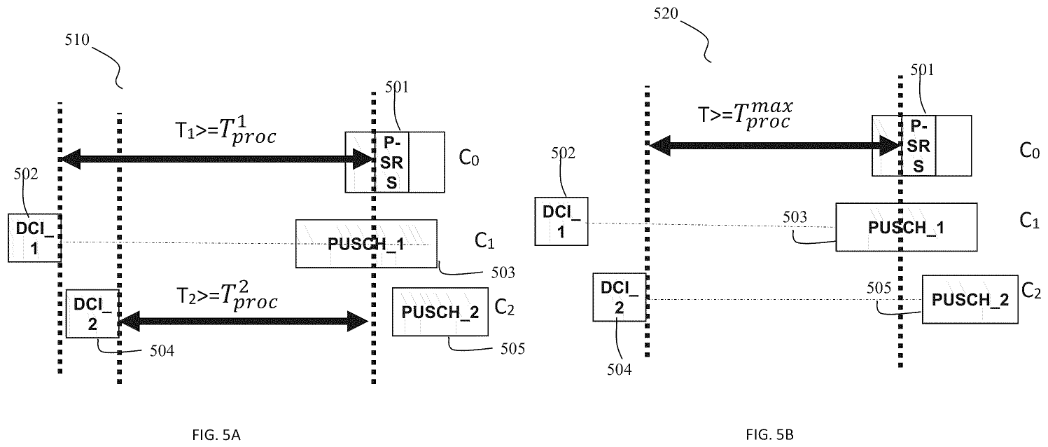

FIG. 3 illustrates an example method 300 performed by a base station for scheduling a SRS transmission and switching in aggregated CCs, according to some aspects of the disclosure. FIGS. 4A-4B and 5A-5B illustrate example timing diagrams with time constraints for a base station to schedule a SRS transmission and switching in aggregated CCs according to method 300. Method 300 can be performed by base station 103 as shown in FIG. 1 or device 200 as shown in FIG. 2.

At 302, base station 103 can receive a UE capability report from a UE to indicate a capability of the UE for simultaneous uplink transmissions over a plurality of CCs and a capability of the UE to use a specific CC as a target carrier for SRS carrier switching. For example, base station 103 can receive UE capability report 137 from UE 101 to indicate a capability of UE 101 for simultaneous uplink transmissions over a plurality of CCs, e.g., carrier 121, carrier 123, or carrier 125. UE capability report 137 can also indicate a capability of UE 101 to use a specific CC as a target carrier for SRS carrier switching.

At 304, base station 103 can generate a DCI to schedule a SRS transmission from the UE on a first CC, where an end symbol of the DCI is separated by a time gap from a start symbol of an UL transmission on a second CC that overlaps in time with the SRS transmission. The UL transmission on the second CC has a priority lower than the SRS transmission on the first CC, and the time gap is at least not less than, or equivalently greater than or equal to, a processing time T_{proc}ⁱ for the UE to cancel the UL transmission on the second CC.

For example, as shown by time diagram 410 in FIG. 4A, base station 103 can generate a DCI 401 that can schedule a SRS 402 to be transmitted over a carrier C0. SRS 402 can be an Ap-SRS. The carrier C0 can be carrier 121 as shown in FIG. 1. In some examples, the carrier C0 is not a regular UL carrier and not configured for PUSCH/PUCCH transmissions. DCI 401 can be of a DCI format 2_3. An UL transmission 403 is scheduled to be transmitted over carrier C1, and an UL transmission 405 is scheduled to be transmitted over carrier C2, where C1 can be carrier 123 and C2 can be carrier 125. UL transmission 403 can be a PUSCH transmission of a periodic Channel State Information (P-CSI) report, while UL transmission 405 can be a P-SRS. Both UL transmission 403 and UL transmission 405 can have a lower priority than SRS 402, and overlap in time with SRS 402. The overlapping between UL transmission 403, UL transmission 405, and SRS 402 can include any interruption due to UL/DL radio frequency (RF) retuning time as defined by higher layer parameters switchingTimeUL and switchingTimeDL of SRS-SwitchingTimeNR.

A time gap T1 between the end symbol of DCI 401 and the start symbol of UL transmission 403 cannot be less than, or equivalently greater than or equal to, T_{proc}¹, which is a processing time for UE 101 to cancel UL transmission 403 on C1 when UE 101 cannot transmit SRS 402 over carrier C0, UL transmission 403 over carrier C1, and UL transmission 405 over carrier C2 simultaneously. Similarly, a time gap T2 between the end symbol of DCI 401 and the start symbol of UL transmission 405 cannot be less than, or equivalently greater than or equal to, T_{proc}², which is a processing time for UE 101 to cancel UL transmission 405 on C2 when UE 101 cannot transmit SRS 402 over carrier C0, UL transmission 403 over carrier C1, and UL transmission 405 over carrier C2 simultaneously.

In some examples, T_{proc}ⁱ is the processing time required for UE to cancel UL transmission on i-th low priority carrier, such as T_{proc}¹ or T_{proc}² shown in FIG. 4A. In some examples, T_{proc}ⁱ can be defined as T_{proc}ⁱ=T_{proc,2}+dⁱ, where T_{proc,2} can be specified by TS 38.214, Sec. 6.4, with d_{2,1}=d_{2,2}=d₂=0, and N2. N2 is determined based on the UE UL processing capability of the i-th UL low priority carrier and subcarrier spacing (SCS) corresponding to the smallest SCS configurations among the SCS for the PDCCH scheduling A-SRS over the target cell, and the SCS for the i-th low priority UL transmission. dⁱ>=0 is based on UE capability if the transmission on the i-th low priority UL carrier is already started. Alternatively, T_{proc}ⁱ for the i-th low priority carrier can be only based on N2, as defined above.

The time gaps T1 and T2 are merely examples to be satisfied by DCI 401 to schedule SRS 402 to be transmitted over carrier C0. Other time constraints can be implemented as well. For example, as shown by time diagram 420 in FIG. 4B, a time gap T can be imposed to separate the end symbol of DCI 401 and both the start symbol of UL transmission 403 and the start symbol of UL transmission 405. The time gap T cannot be less than, or equivalently greater than or equal to, T_{proc}^{max}, with T_{proc}^{max}=max {T_{proc}¹, . . . , T_{proc}ⁱ, . . . }, where T_{proc}ⁱ is as defined above for FIG. 4A. The time gap T is at least as large as individual T_{proc}ⁱ so that there is enough time for UE 101 to cancel any of the UL transmissions when UE 101 cannot transmit SRS 402 over carrier C0, UL transmission 403 over carrier C1, and UL transmission 405 over carrier C2 simultaneously. In general, base station 103 can keep a time gap between the last symbol of DCI 401 indicating an Ap-SRS on target CC and the first symbol of the earliest low priority UL transmission, among a group of overlapping UL transmissions with a priority lower than A-SRS, not to be less than, or equivalently greater than or equal to, T_{proc}^{max}.

At 306, base station 103 can generate a DCI to trigger a UL transmission on a first CC between the UE and the base station, when: a start symbol of a SRS transmission from the UE on a second CC is separated by a time gap from an end symbol of the DCI, the UL transmission on the first CC has a priority higher than the SRS transmission, the UL transmission on the first CC overlaps in time with the SRS transmission, and the time gap is at least not less than, or equivalently greater than or equal to, a processing time T_{proc}ⁱ for the UE to switch SRS transmission to the second CC.

For example, as shown by time diagram 510 in FIG. 5A, base station 103 can generate a DCI 502 to trigger an UL transmission 503 on a first CC, C1, between UE 101 and base station 103. DCI 502 can be of a DCI format 1. A SRS transmission 501 from UE 101 is scheduled on CC C0. SRS transmission 501 can be a P-SRS, which can be a low priority SRS. The UL transmission 503 on C1 has a priority higher than the SRS transmission 501 on C0. The UL transmission 503 on C1 overlaps in time with the SRS transmission 501. A start symbol of SRS transmission 501 on C0 is separated by a time gap T_{proc}¹ from an end symbol of DCI 502. The time gap T_{proc}¹ is at least not less than, or equivalently greater than or equal to, a processing time for the UE to switch SRS transmission to C0. Similarly, base station 103 can generate a DCI 504 to trigger an UL transmission 505 on a CC, C2, between UE 101 and base station 103. DCI 504 can be of a DCI format 2. The UL transmission 505 on C2 has a priority higher than the SRS transmission 501 on C0. The UL transmission 505 on C2 overlaps in time with the SRS transmission 501 on C0. The start symbol of SRS transmission 501 on C0 is separated by a time gap T_{proc}² from an end symbol of DCI 504. The time gap T_{proc}² is at least not less than, or equivalently greater than or equal to, a processing time for the UE to switch SRS transmission to C0 from a source carrier, not shown. In some examples, T_{proc}ⁱ, such as T_{proc}¹ and T_{proc}², can be defined as T_{proc}ⁱ=SRS-SwitchingTime+N, where N is a constant selected based on the UE reported capability as the minimum time interval in unit of symbols, between the DCI and SRS transmission, and is determined based on the numerology of the switch to cell and the cell carrying the grant.

The time gap T1 and T2 are merely examples to be satisfied by DCI 502 and DCI 504 to schedule UL transmissions to be transmitted over CCs that are transmitted simultaneously with SRS transmission. Other time constraints can be implemented as well. For example, as shown by time diagram 520 in FIG. 5B, a time gap T can be imposed to separate the start symbol of SRS transmission 501 and end symbol of DCI 502 and the end symbol of DCI 504. The time gap T cannot be less than, or equivalently greater than or equal to, T_{proc}^{max}, with T_{proc}^{max}=max {T_{proc}, . . . , T_{proc}, . . . }, where T_{proc}ⁱ is as defined above for FIG. 5A. The time gap T is at least as large as individual T_{proc}ⁱ. In general, when UE 101 is scheduled by a DCI, or a set of DCIs, to transmit a high priority UL transmissions on a serving cell overlapping with a low priority SRS transmission on a carrier without configured PUSCH/PUCCH, including any interruption due to UL/DL RF retuning time, and simultaneous transmission is beyond UE's capability, the base station can keep the gap between the first symbol of the earliest low priority SRS transmission on the target cell and a last symbol of the last DCI among all DCIs indicating high priority transmissions on another carriers, is not less than, or equivalently greater than or equal to, T_{proc}^{max} with T_{proc}^{max}=max {T_{proc}¹, . . . , T_{proc}ⁱ, . . . }.

In addition to the constraints on the time gap between various DCIs and the SRS transmissions, the base station can also follow some additional rules in scheduling DCIs. For example, if base station 103 has already scheduled a DCI that triggers a higher priority UL transmission in CC C1, base station 103 may not schedule another DCI that triggers a low priority UL transmission in CC C2 that overlaps with the higher priority UL transmission in C1. Hence, UE 101 may not monitor any DCIs that may trigger a lower priority UL transmission. As another example, if base station has already scheduled a higher priority periodic (or semi-persistent) UL transmission in CC C1, base station 103 may not schedule another DCI that triggers a low priority UL transmission in CC C2 that overlaps with the higher priority UL transmission in C1.

In some examples, if base station 103 does not follow the time constraints illustrated in operations at 304 or 306, UE 101 can perform various operations according to some illustrative examples. For example, UE 101 may not cancel low priority channel transmissions (keep transmission of low priority channel), and UE 101 may not transmit the high priority UL channel transmissions. Alternatively, UE 101 can cancel low priority channel transmissions, but UE 101 may not transmit high priority channel transmissions. The cancellation of low priority channel transmissions may partially or fully depend on UE capability. Alternatively, subject to UE capability, UE 101 can partially cancel low priority channel transmissions, and UE 101 may transmit (partially or fully) high priority channel transmissions. In some other examples, UE 101 may simply treat the DCIs as an error case and UE behavior is undefined.

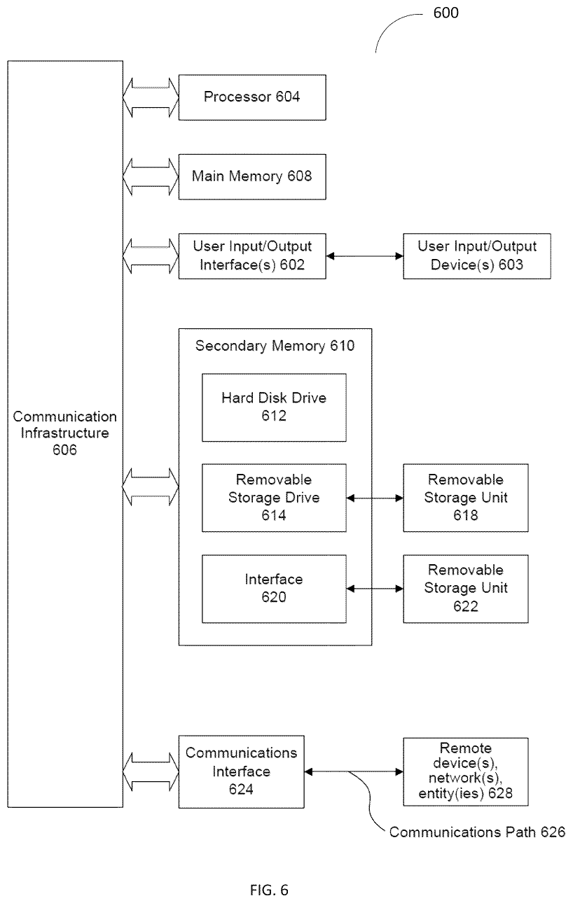

Various aspects can be implemented, for example, using one or more computer systems, such as computer system 600 shown in FIG. 6. Computer system 600 can be any computer capable of performing the functions described herein such as UE 101, base station 103, base station 105, base station 107, or device 200 as shown in FIG. 1 and FIG. 2, and operations shown in FIG. 3, FIGS. 4A-4B, and FIGS. 5A-5B. Computer system 600 includes one or more processors (also called central processing units, or CPUs), such as a processor 604. Processor 604 is connected to a communication infrastructure 606 (e.g., a bus). Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 608, the removable storage unit 618, the removable storage unit 622 can store instructions that, when executed by processor 604, cause processor 604 to perform operations for a UE or a base station, e.g., UE 101, base station 103, base station 105, base station 107, or device 200 as shown in FIG. 1 and FIG. 2. In some examples, the operations include those operations illustrated and described in FIG. 3, FIGS. 4A-4B, and FIGS. 5A-5B.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626. Operations of the communication interface 624 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A base station, comprising:
a transceiver configured to enable wireless communication with a user equipment (UE) through a plurality of component carriers (CCs); and
a processor communicatively coupled to the transceiver and configured to:
generate a Downlink Control Information (DCI) to schedule a sounding reference signal (SRS) transmission from the UE on a target reference CC selected from the plurality of CCs, wherein an end symbol of the DCI is separated by a time gap from a start symbol of a uplink (UL) transmission on a transmission CC that overlaps in time with the SRS transmission, wherein the UL transmission on the transmission CC has a lower priority than the SRS transmission on the target reference CC, and the time gap is greater than or equal to a processing time for the UE to cancel the UL transmission on the transmission CC; and
transmit, using the transceiver, the DCI to the UE.

2. The base station of claim 1, wherein the processor is further configured to:
receive, using the transceiver, the UL transmission from the UE on the transmission CC; and
receive, using the transceiver, the SRS transmission from the UE on the target reference CC,
wherein the UL transmission on the transmission CC and the SRS transmission on the target reference CC are transmitted simultaneously.

3. The base station of claim 1, wherein the processor is further configured to:
receive, using the transceiver, the SRS transmission from the UE on the target reference CC, without receiving the UL transmission from the UE on the transmission CC.

4. The base station of claim 1, wherein the SRS transmission is an aperiodic SRS signal transmission triggered by the DCI.

5. The base station of claim 1, wherein the time gap is greater than or equal to the processing time for the UE to cancel the UL transmission on the transmission CC plus a constant determined based on a capability of the UE.

6. The base station of claim 1, wherein the UL transmission is a first UL transmission transmitted on a first transmission CC, and the UE is scheduled to transmit a second UL transmission on a second transmission CC that has a priority lower than the SRS transmission on the target reference CC, wherein the second UL transmission on the second transmission CC overlaps in time with the SRS transmission,
wherein the end symbol of the DCI is separated by at least a second time gap from a symbol that is an earliest symbol between the start symbol of the first UL transmission and a start symbol of the second UL transmission, and the second time gap is greater than or equal to a processing time that is greater than or equal to a first processing time for the UE to cancel the first UL transmission on the first transmission CC, and a second processing time for the UE to cancel the second UL transmission on the second transmission CC.

7. The base station of claim 1, wherein the DCI is a first DCI, and the UL transmission is a first UL transmission, and the processor is further configured to:
generate a second DCI to schedule a second UL transmission from the UE on a second transmission CC that has a priority higher than the SRS transmission on the target reference CC, wherein the second UL transmission on the second transmission CC overlaps in time with the SRS transmission,
wherein a start symbol of the SRS transmission is separated by a second time gap from an end symbol of the second DCI, and the second time gap is greater than or equal to a processing time for the UE to switch the SRS transmission to the target reference CC from a source CC.

8. The base station of claim 7, wherein the processor is further configured to:
receive, using the transceiver, the second UL transmission from the UE on the second transmission CC; and
receive, using the transceiver, the SRS transmission from the UE on the target reference CC,
wherein the second UL transmission on the second transmission CC and the SRS transmission on the target reference CC are transmitted simultaneously.

9. The base station of claim 7, wherein the processor is further configured to:
receive, using the transceiver, the second UL transmission from the UE on the second transmission CC, without receiving the UL transmission from the UE on the transmission CC.

10. The base station of claim 1, wherein the processor is further configured to:
receive, using the transceiver, a UE capability report from the UE to indicate a capability of the UE for transmitting the UL transmission on the transmission CC and the SRS transmission on the target reference CC simultaneously, and a capability of the UE to use a specific component carrier (CC) as a target carrier for SRS carrier switching.

11. A User Equipment (UE), comprising:
a transceiver configured to enable wireless communication with a base station through a plurality of component carriers (CCs); and
a processor communicatively coupled to the transceiver and configured to:
receive, using the transceiver, a Downlink Control Information (DCI) to schedule a sounding reference signal (SRS) transmission from the UE on a target reference CC selected from the plurality of CCs,
determine whether a time constraint is satisfied, wherein the time constraint is a time gap between an end symbol of the DCI and a start symbol of a uplink (UL) transmission on a transmission CC that overlaps in time with the SRS transmission, wherein the UL transmission on the transmission CC has a lower priority than the SRS transmission on the target reference CC;
in response to a determination that the time constraint is satisfied, transmit, using the transceiver, a SRS signal in the SRS transmission scheduled by the DCI.

12. The UE of claim 11, wherein the processor is further configured to:
determine whether the UE has a capability to transmit the UL transmission on the transmission CC and the SRS transmission on the target reference CC simultaneously; and
based on a determination that the UE has the capability, transmit, using the transceiver, the UL transmission on the transmission CC to the base station.

13. The UE of claim 12, wherein the processor is further configured to:
based on determination that the UE does not have the capability, cancel the UL transmission on the transmission CC to the base station after receiving the DCI.

14. The UE of claim 11, wherein the processor is further configured to:
in response to a determination that the time constraint is not satisfied, transmit the UL transmission on the transmission CC using the transceiver to the base station, without transmitting the SRS transmission when the UE does not have a capability to transmit the UL transmission on the transmission CC and the SRS transmission on the target reference CC, simultaneously.

15. The UE of claim 11, wherein the time gap is greater than or equal to a processing time for the UE to cancel the UL transmission on the transmission CC.

16. The UE of claim 11, wherein the DCI is a first DCI, the time constraint is a first time constraint, and the processor is configured to:
receive, using the transceiver, a second DCI to schedule a second UL transmission from the UE on a second transmission CC that has a priority higher than the SRS transmission on the target reference CC, wherein the second UL transmission on the second transmission CC overlaps in time with the SRS transmission;
determine whether a second time constraint is satisfied, wherein the second time constraint is a second time gap between a start symbol of the SRS transmission and an end symbol of the second DCI;
in response to a determination that the second time constraint is satisfied, transmit the SRS signal in the SRS transmission scheduled by the first DCI.

17. The UE of claim 16, wherein the second time gap is greater than or equal to a processing time for the UE to switch the SRS transmission to the target reference CC from a source CC.

18. A method for a base station, comprising:
generating a first Downlink Control Information (DCI) to schedule a sounding reference signal (SRS) transmission from a user equipment (UE) on a target reference CC selected from a plurality of CCs; and
generating a second DCI to schedule an uplink (UL) transmission from the UE on a transmission CC that has a priority higher than the SRS transmission on the target reference CC,
transmitting the first DCI and the second DCI to the UE;
wherein the UL transmission on the transmission CC overlaps in time with the SRS transmission, and wherein a start symbol of the SRS transmission is separated by a time gap from an end symbol of the second DCI, and the time gap is greater than or equal to a processing time for the UE to switch the SRS transmission to the target reference CC from a source CC.

19. The method of claim 18, further comprising:
receiving the UL transmission from the UE on the transmission CC; and
receiving the SRS transmission from the UE on the target reference CC,
wherein the UL transmission on the transmission CC and the SRS transmission on the target reference CC are transmitted simultaneously.

20. The method of claim 18, further comprising:
receiving a UE capability report from the UE to indicate a capability of the UE for transmitting the UL transmission on the transmission CC and the SRS transmission on the target reference CC simultaneously, and a capability of the UE to use a specific component carrier (CC) as a target carrier for SRS carrier switching.
